(19) United States
(12) Patent Application Publication
(10) Pub. No.: US 2011/0148938 A1
(43) Pub. Date: Jun. 23, 2011

(54) DISPLAYED CONTENTS SECURING SYSTEM AND METHOD, AND DISPLAYED CONTENTS VIEWING DEVICE

(75) Inventor: Huizhou YANG, Beijing (CN)

(73) Assignee: IGRS ENGINEERING LAB LTD., Beijing (CN)

(21) Appl. No.: 12/786,235

(22) Filed: May 24, 2010

(30) Foreign Application Priority Data
Dec. 18, 2009 (CN) 200910260664.0

(51) Int. Cl. G09G 5/10; G02F 1/01

(52) U.S. Cl. 345/690; 359/238

(57) ABSTRACT

A system and method for securing contents displayed on a display device, and a device for viewing displayed content are provided. The system may include a first device and a communication module. The communication module may be adapted to communicatively connect the first device to the display device. The first device may be adapted to control, via the communication module, the display device to alternately display a first content and a second content. The second content may contain interference information. The device for viewing displayed content may be adapted to alternately let light through and shut off light. With the device for viewing displayed content, the first content displayed is viewable by an intended viewer while the second content displayed is un-viewable by the intended viewer.

### CROSS-REFERENCE TO RELATED APPLICATION

This application claims priority to Chinese patent application no. 200910260664.0, filed Dec. 18, 2009, which is incorporated herein by reference.

### TECHNICAL FIELD

The present disclosure relates to the field of information security, and more particularly, to a displayed contents securing system and method, and a displayed contents viewing device.

### BACKGROUND ART

Many devices, such as a Personal Computer (PC), a Personal Digital Assistance (PDA), a cell phone, an audio and video player, a television, an electronic game machine, and the like, are equipped with a display screen for displaying visual contents to a user/viewer. In some cases, the user of a device may desire to keep the displayed contents confidential, that is, he/she does not want other persons next to him/her to see the contents.

Secure screen is an existing solution. In such a solution, a secure screen is installed in front of the display screen of a device so that the contents displayed on the display screen can be seen only when the viewer is within a certain angle range in front of the display screen. With the method, the user of the device can prevent other persons outside the angle range from viewing the displayed contents.

### SUMMARY

Some embodiments of the present disclosure provide a system and a method for securing contents displayed on a display device, so that the contents displayed on the display device can be recognizable by only an intended viewer.

An embodiment of the present disclosure provides a system for securing contents displayed on a display device. The system may include a first device and a communication module. The communication module may be adapted to communicatively connect the first device to the display device. The first device may be adapted to control, via the communication module, the display device to alternately display a first content and a second content, the second content containing interference information.

Another embodiment of the present disclosure provides a device for permitting displayed content to be viewed while securing the displayed content. The device may include a light blocking device that is adapted to be alternately turned on to let light through when first content is displayed on a display device and be turned off to shut off light when second content is displayed on the display device.

Another embodiment of the present disclosure provides a method for securing displayed contents. The method may include: alternately displaying a first content containing information intended to be viewed and a second content containing interference information; and enabling the displayed second content to be un-viewable by an intended viewer.

Another embodiment of the disclosure provides a program product including machine-executable instructions which, when executed by an information processing device, causes the information processing device to perform the method described above.

Another embodiment of the disclosure provides a machine-readable medium having machine-readable program code embodied therein for causing an information processing device to perform the method described above.

The foregoing is a summary and thus contains, by necessity, simplifications, generalization, and omissions of detail(s). Consequently, those skilled in the art will appreciate that the summary is illustrative only and is not intended to be in any way limiting. Other aspects, features, and advantages of the apparatus and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the present disclosure and are, therefore, not to be considered limiting of its scope, the present disclosure will be described with additional specificity and detail through use of the accompanying drawings.

FIG. 1 is a schematic diagram illustrating a system for securing contents displayed on a display device according to an embodiment of the disclosure;

FIG. 2 is a schematic diagram showing an example of the first content containing information to be viewed, the second content containing interference information and the vision presented when the two contents are alternately displayed on the display device according to the embodiment as shown in FIG. 1;

FIG. 3 is a schematic diagram showing another example of the first content, the second content and the vision presented when the two contents are alternately displayed on the display device according to the embodiment as shown in FIG. 1;

FIG. 4 is a schematic diagram illustrating a system for securing contents displayed on a display device according to another embodiment of the disclosure;

FIG. 5 is a schematic diagram illustrating a system for securing contents displayed on a display device according to another embodiment of the disclosure;

FIG. 6 is a schematic diagram illustrating a system for securing contents displayed on a display device according to another embodiment of the disclosure;

FIG. 7 is a schematic diagram illustrating a system for securing contents displayed on a display device according to another embodiment of the disclosure;

FIG. 8 is a schematic flow chart illustrating a method for securing displayed contents displayed according to an embodiment of the present disclosure;

FIG. 9 is a schematic flow chart illustrating a method for securing displayed contents displayed according to another embodiment of the present disclosure;

FIG. 10 is a schematic flow chart illustrating a method for securing displayed contents displayed according to another embodiment of the present disclosure;

FIG. 11 is a schematic flow chart illustrating a method for securing displayed contents displayed according to another embodiment of the present disclosure;

FIG. 12 is a schematic flow chart illustrating a method for securing displayed contents according to another embodiment of the present disclosure; and

FIGS. 13(A) and (B) are schematic diagrams illustrating the operating principle of an exemplary viewing device according to an embodiment of the present disclosure.

### DESCRIPTION OF EMBODIMENTS

In the following detailed description, reference is made to the accompanying drawings, which form a part hereof. In the drawings, similar symbols typically identify similar components, unless the context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to systems, methods, program products and medium related to security of displayed contents.

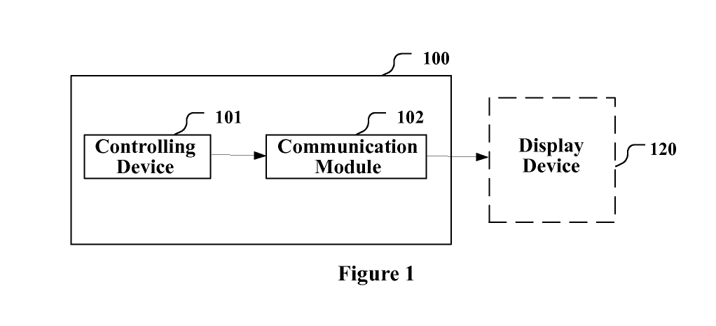

FIG. 1 is a schematic diagram of a system for securing contents displayed on a display device according to an embodiment of the disclosure.

As shown in FIG. 1, the system 100 for securing contents displayed on a display device may include a controlling device 101 and a communication module 102. The communication module 102 may be adapted to communicatively connect the controlling device 101 to the display device 120. In an example, the communication module 102 may be a communication interface that may connect the controlling device 101 to the display device 120 in a wireless or wired manner. As an example, the communication module 102 may be a Bluetooth interface connecting the controlling device 101 to the display device 120 wirelessly according to the Bluetooth standard. As another example, the communication module 102 may be a serial port connecting the controlling device 102 to the display device 120 via a cable. It can be appreciated that these examples are merely illustrative. The communication module 102 may be implemented according to any appropriate technologies which are not enumerated herein.

The controlling device 101 may be adapted to control the display device 120 via the communication module 102 so that the display device 120 may alternately display a first content and a second content. The first content may contain information intended to be viewed by an intended user, and the second content may contain interference information. The second content is used as interference to the first content, and therefore may also be called as “the interferential content”. The first content or the second content may include image, picture, video, text and/or any other information that can be displayed on a screen of a display device.

With the above system 100, what is presented on the display device 120 is a combination of the first content and the second content that are displayed alternately, which leads to an unrecognizable vision to a non-intended viewer due to the phenomenon of persistence of vision.

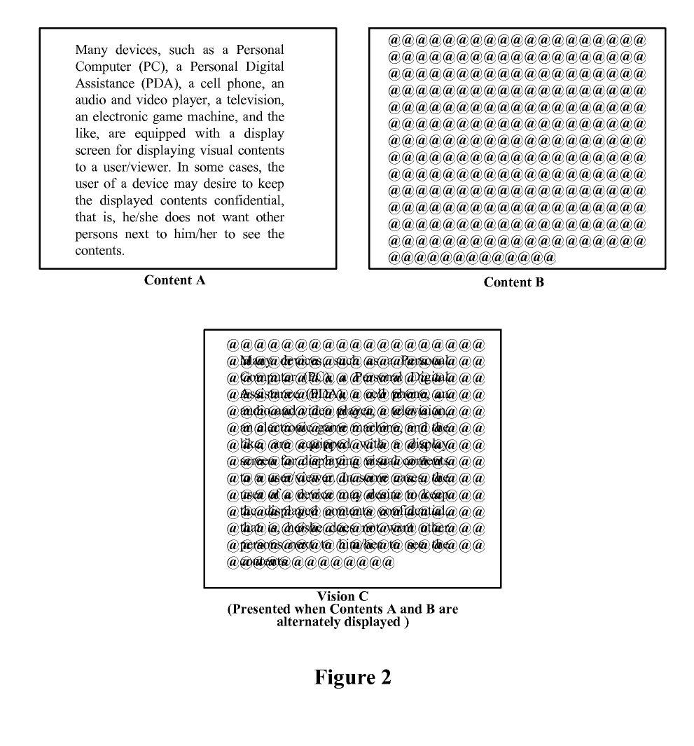

FIG. 2 shows an example of the first content and the interferential content and the vision when the two contents are displayed alternately. As shown in FIG. 2, the content A is an example of the first content, the content B is an example of the interferential content. When the content A and the content B are displayed alternately on the display device with a certain duration, the vision C presented is visually unrecognizable as shown in FIG. 2.

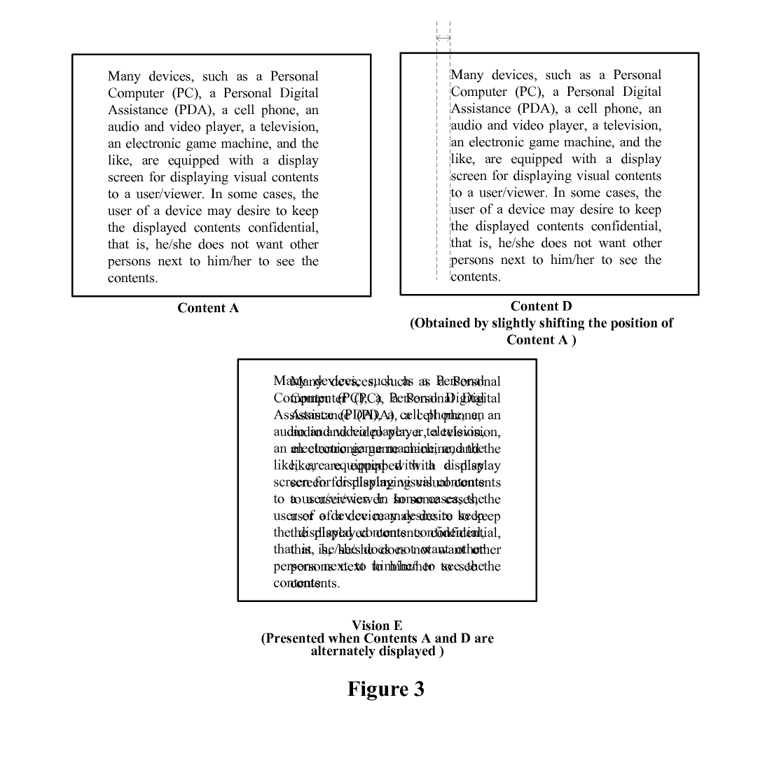

FIG. 3 shows another example of the first content and the interferential content and the vision when the two contents are displayed alternately. As shown in FIG. 3, the content A is the same as that shown in FIG. 2, and the content D is an image obtained by shifting the position of the image of content A. The vision E is presented when the contents A and D are alternately displayed. As can be seen, though different interferential contents are used, the visions C and E presented are both visually unrecognizable.

With the system 100 as shown in FIG. 1, the displayed content that is intended to be viewed by an intended viewer can be kept confidential to non-intended viewers.

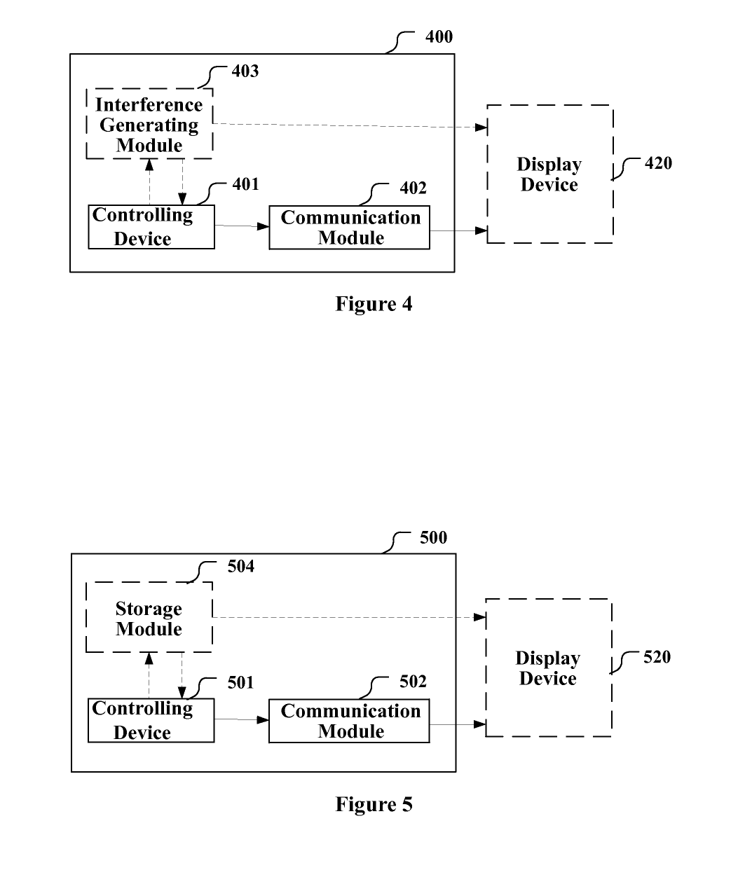

FIG. 4 is a schematic diagram of a system for securing contents displayed on a display device according to another embodiment of the disclosure.

The system 400 as shown in FIG. 4 may include a controlling device 401 and a communication module 402, and may further include an interference generating module 403. The controlling device 401 may be operably connected to the interference generating module 403. In addition, the communication module 402 may communicatively connect the controlling device 401 to the display device 420. The communication module 402 is similar to the communication module 102 as shown in FIG. 1, and thus the description of the communication module 402 is omitted herein.

The controlling device 401 has the functions of the controlling device 101 as shown in FIG. 1. In addition the controlling device 401 is further adapted to control the interference generating module 403.

The interference generating module 403 may be adapted to generate the interferential content under the control of the controlling device 401. In an example, the interference generating module 403 may be adapted to send the generated interferential content to the controlling device 401 and the controlling device 401 may be further adapted to send the interferential content to the display device 420 via the communication module 402. In another example, the interference generating module 403 may be operably connected to the display device 420, e.g. via the communication module 402 or other communication interface, and may be further adapted to send the generated interferential content to the display device 420.

The interferential content may be generated in many ways. For example, in the MS WINDOWS environment of a computer, the image of the first content (e.g. the Content A as shown in FIG. 3) displayed on the display device 420 can be captured, then the image of the interferential content (e.g. the Content D as shown in FIG. 3) can be formed by shifting the position of the content in the captured image in any arbitrary direction. In another example, the interferential content may be generated using a text that contains arbitrary symbols, letters or words (e.g. Content B as shown in FIG. 2), or using any graphical image or video or other appropriate visual contents. The described examples for generating the interferential content are only illustrative, and should not be regarded as limiting the disclosure thereto.

In an example, the interference generating module 403 may be integrated in the display device 420. In another example, the interference generating module 403 may be integrated with the controlling device 401.

FIG. 5 is a schematic diagram of a system for securing contents displayed on a display device according to another embodiment of the disclosure.

The system 500 as shown in FIG. 5 may include a controlling device 501 and a communication module 502, and may further include a storage module 504. The controlling device 501 may be operably connected to the storage module 504. In addition, the controlling device 501 may be operably connected to the display device 520 via the communication module 502. The communication module 502 is similar to the communication module 102 as shown in FIG. 1, and thus the description of the communication module 502 is omitted herein.

The controlling device 501 has the functions of the controlling device 101 as shown in FIG. 1. In addition the controlling device 501 is further adapted to control the storage module 504.

The storage module 504 may store the interferential content to be displayed on the display device 520. In an example, the controlling device 501 may be adapted to obtain the interferential content from the storage module 504 and send the interferential content to the display device 520 via the communication module 502. In another example, the storage module 504 may be operably connected, e.g. via the communication module 502 or other communication interface, to the display device 520 which may obtain the interferential content from the storage module 504.

As an example, the storage module 504 may be integrated in the display device 520. As another example, the storage module 504 may be integrated with the controlling device 501.

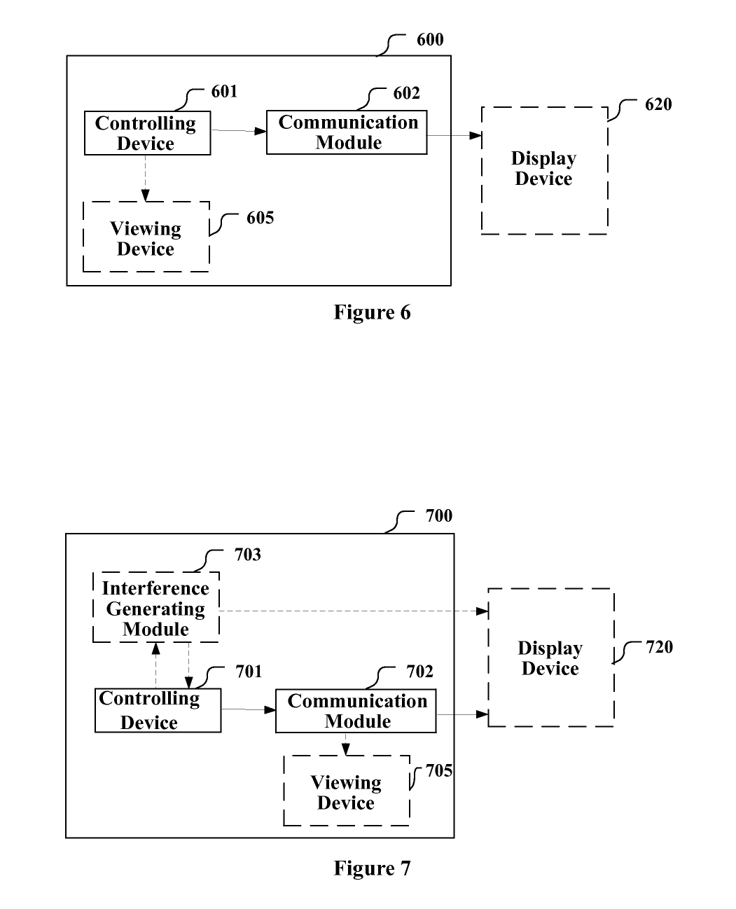

FIG. 6 is a schematic diagram of a system for securing contents displayed on a display device according to another embodiment of the disclosure.

The system 600 as shown in FIG. 6 may include a controlling device 601, a communication module 602, and may further include a viewing device 605. Similar to the communication module 102, the communication module 602 may be adapted to operably connect the controlling device 601 to the display device 620.

The functions of the controlling device 601 are similar to those of the controlling device 101 as shown in FIG. 1, the description of which is omitted herein.

The viewing device 605 may be adapted to enable the first content displayed on the display device 620 to be viewable by an intended viewer and enable the second content displayed on the display device 620 to be un-viewable by the intended viewer. Particularly, the viewing device 605 may operate synchronously with the display device 620. As an example, the viewing device 605 may be a light blocking device. The light blocking device may be turned on to let light through when the first content is displayed on the display device 620 and may be turned off to shut off light when the interferential content is displayed. In this way, when the light blocking device is positioned between the display device 620 and the eyes of the intended viewer, what is seen by the intended viewer is a combination of the first content images and the blanks provided by the light blocking device that are presented alternately, which leads to a recognizable vision of the first content. However, for a person without the light blocking device, due to the phenomenon of persistence of vision, what is seen by him/her is a combination of the first content images and the interferential content images that are displayed alternately, which leads to an unrecognizable vision.

In an example, the communication module 602 may be further adapted to operably connect the controlling device 601 to the viewing device 605 so that the controlling device 601 may control the viewing device 605 and the display device 620 in a synchronized manner. Under the control of the controlling device 601, the viewing device 605 enables the first content displayed on the display device 620 to be viewable by an intended viewer and the second content displayed on the display device 620 to be un-viewable by the intended viewer. In the case that the viewing device 605 is the light blocking device, the controlling device 601 may control the light blocking device to let light through when the first content is displayed on the display device 620 and shut off light when the interferential content is displayed on the display device 620.

In another example, the viewing device 605 may be controlled manually by the viewer so as to operate synchronously with the display device 620. In the case that the viewing device 605 is the light blocking device, the light blocking device is controlled manually to let light through when the first content is displayed and shut off light when the interferential content is displayed. For example, the manual control may be implemented by use of an adjusting unit (for example, one or more buttons or pressing keys) of the light blocking device, by which the viewer may adjust the duration of letting light through and the duration of shutting off light of the light blocking device and the starting time points of the durations.

FIG. 7 is a schematic diagram of a system for securing contents displayed on a display device according to another embodiment of the disclosure.

The system 700 as shown in FIG. 7 may include a controlling device 701, a communication module 702, a viewing device 705, and an interference generating module 703. The controlling device 701 may be operably connected to the interference generating module 703. Similar to the communication module 102, the communication module 702 may be adapted to operably connect the controlling device 701 to the display device 720. In addition, the communication module 702 may be further adapted to operably connect the controlling device 701 to the viewing device 705, so that the controlling device 701 may control the viewing device 705 and the display device 720 in a synchronized manner.

The functions of the interference generating module 703 are similar to the interference generating module 403 as shown in the above embodiments and examples, the functions of the viewing device 705 are similar to the viewing device 605 as shown in the above embodiments and examples, and the functions of the controlling device 701 are similar to the controlling device 601 as shown in the above embodiments and examples, the description of which is omitted herein.

In another embodiment, the controlling device 101/401/501/601/701 may be further adapted to configure a first duration of displaying the first content and a second duration of displaying the interferential content, so that the display device 120/420/520/620/720 displays the first content during the first duration and displays the interferential content during the second duration, and the viewing device 605/705 lets light through during the first duration and shuts off light during the second duration.

In an example, the first and second durations may be set and adjusted automatically by the controlling device 101/401/501/601/701. In another example, the first and second durations may be set and adjusted by a viewer/user via an input device of the controlling device 101/401/501/601/701, which is not shown in the figures. For example, the input device may include a keyboard, a mouse and the like, operably connected to the controlling device 101/401/501/601/701, or may further include a software interface (such as a scroll bar, an input field and the like). The input device may be implemented in many ways according to any appropriate technologies. The described examples of the input device are only illustrative, are not intended to limit the disclosure thereto.

By adjusting the durations for displaying the first content and the interferential content, an advantageous screen securing effect may be achieved.

In another example, to control the viewing device 605/705 and the display device 120/420/520/620/720, the controlling device 101/401/501/601/701 may generate a control signal and simultaneously send the control signal to the viewing device and the display device. The control signal may have at least two signal states (referred to as a first state and a second state below). For example, the control signal may be a sequence of alternate 1s and 0s over time, and the 1s and 0s can have different durations, respectively. For instance, all the 1s and all the 0s can have a same duration of 0.02 second, or all the 1s can have a same duration of 0.02 second while all the 0s can have a same duration of 0.01 second. It shall be appreciated that the particular values of the durations described herein are only examples. The durations can be set to any appropriate values according to the practical requirements, and should not be limited to the particular values described herein. As described above, the duration of 1s and 0s may be set and adjusted automatically, or may be set and adjusted by a user using an input device (such as a keyboard, a mouse and the like) connected to the controlling device and a software interface (such as a scroll bar, an input field and the like).

Under the control of the control signal, the first content and the interferential content are alternately displayed on the display screen. At the same time, the viewing device may alternately let light through or shut off light according to the control signal. For example, when the control signal is in the first state (for example, during the duration of 1), the first content may be displayed and the viewing device may turn on to allow light to go through, such that the content displayed on the display screen can be seen by the intended viewer/user, and when the control signal is in the second state (for example, during the duration of 0), the interferential content is displayed and the viewing device may turn off to block light such that the interferential content displayed on the screen can not seen by the intended viewer/user.

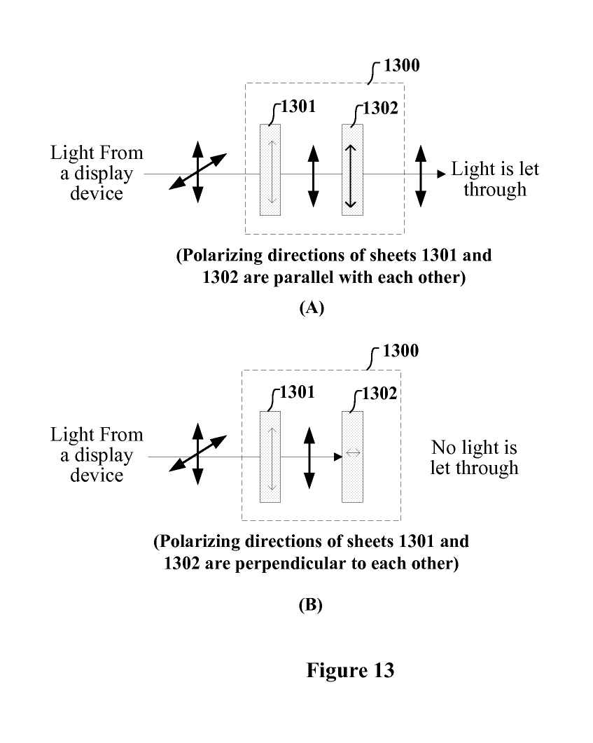

The viewing device 605/705, when utilized, may be disposed between the eyes of an intended viewer and the display device 620/720. In an example, the viewing device may be a polarizer device that can be controlled to allow or not allow the light to go through. FIGS. 13(A) and (B) illustrate an example of the polarizer device. In the example as shown in FIGS. 13(A) and (B), the polarizer device 1300 may include two polarizing sheets 1301 and 1302, When utilized, the two polarizing sheets may be disposed in parallel between the display device 620/720 and the eyes of an intended viewer. As shown in FIG. 13(A), when the first content is displayed on the display device, the polarizing directions of the two polarizing sheets 1301 and 1302 are controlled to be parallel with each other so as to allow the light to go through. As shown in FIG. 13(B), when the interferential content is displayed on the display device, the polarizing directions of the two polarizing sheets 1301 and 1302 are controlled to be perpendicular to each other so that the light can not go through the two sheets. The polarizing directions of the two polarizing sheets may be controlled by using any appropriate technologies, the description of which is omitted herein. For example, the polarizing sheet may include liquid crystal, the polarizing direction of which may be changed by applying a certain voltage thereto. In addition, besides the two polarizing sheets disposed in parallel, the viewing device may be implemented according to any other appropriate technologies, the description of which is omitted herein.

In another example, the viewing device 605/705 may be made in the form of a pair of spectacles that can be worn by a viewer. The pair of spectacles may be controlled to simultaneously let light through when the first content is displayed on the display device 620/720 and simultaneously shut off light when the interferential content is displayed on the display device 620/720. For example, each of the two spectacles may be implemented as a polarizer device including two polarizing sheets disposed in parallel as described in the above example as shown in FIGS. 13(A) and (B). For clarity of the description, the pair of spectacles may be referred to a left spectacle and a right spectacle (corresponding two the left and right eyes of a viewer, respectively). Each of the left and right spectacles includes two polarizing sheets disposed in parallel. When the first content is displayed, the polarizing directions of the two polarizing sheets of the left spectacles are controlled to be parallel with each other and at the same time the polarizing directions of the two polarizing sheets of the right spectacles are controlled to be parallel with each other, too, so that both of the two spectacles may allow light to go through. When the second content is displayed, the polarizing directions of the two polarizing sheets of the left spectacles are controlled to be perpendicular to each other and at the same time the polarizing directions of the two polarizing sheets of the right spectacles are controlled to be perpendicular to each other, too, so that both of the two spectacles do not allow light to go through. Of course, the spectacles may be implemented according to any other appropriate technologies, the description of which is omitted herein. As an example, the two spectacles may be controlled by, for example, the above described control signal generated by the controlling device. In response to the control signal, the left and right spectacles are both turned on during the durations of the first state of the control signal to let light through and are both turned off during the durations of the second state of the control signal to shut off light. In this way, a viewer who wears such a pair of spectacles can view the first content displayed on the display device, while the displayed second content is un-viewable to him/her.

In another example, the viewing device 605/705 may include a first polarizing sheet to be positioned in front of the display screen of the display device 620/720 and a pair of spectacles to be worn by the intended viewer. The pair of spectacles includes a left spectacle and a right spectacle corresponding to the left and right eyes of the viewer, respectively. Each of the spectacles may be made of a polarizing sheet, and the polarizing directions of the two spectacles are kept the same with each other during operation. For example, the pair of spectacles may be controlled, e.g., by the above described control signal from the controlling device. When the control signal is in the first state and the first content is displayed on the display device 620/720, the polarizing directions of the two spectacles may be controlled to be both parallel with that of the first polarizing sheet so that the intended viewer can view the first content, and when the control signal is in the second state and the second content is displayed on the display device 620/720, the polarizing directions of the two spectacles may be controlled to be both perpendicular to that of the first polarizing sheet so that the intended viewer can not see the second content. For another example, the polarizing directions of the two spectacles may keep the same with each other and unchanged, while the first polarizing sheet may be controlled by the above described control signal from the controlling device to change its polarizing direction. When the control signal is in the first state and the first content is displayed on the display device 620/720, the polarizing direction of the first polarizing sheet may be controlled to be parallel with those of the two spectacles, and when the control signal is in the second state and the second content is displayed on the display device 620/720, the polarizing direction of the first polarizing sheet may be controlled to be perpendicular to those of the two spectacles. In an example, the first polarizing sheet may be integrated with the display device 620/720.

The connections between the components/modules/devices described above, e.g. the connections between the controlling device 601/701 and the viewing device 605/705 via the communication module 602/702, the connections between the communication module 102/402/502/602/702 and the display device 120/420/520/620/720 and the connections between the storage module 504/interference generating module 403 and the display device 520/420, may be implemented in a wired or wireless manner according to any appropriate technology. As an example, the connection may be a wireless connection such as a Bluetooth connection, or may be a cabled connection such as a serial communication. As an example, the communication module 102/402/502/602/702 may be a Bluetooth interface or a serial port. Of course, these examples are merely illustrative rather than exhaustive. The appropriate technologies that can be utilized to implement the connections and the communication module are not enumerated herein only for the sake of clarity.

In the above embodiments, the viewing device 605/705 is separated from the display device 620/720.

In an example, the controlling device 101/401/501/601/701 may be embedded in the display device 120/420/520/620/720. In another example, part of the controlling device 601/701 may be integrated with the viewing device 605/705 to control the viewing device 605/705, while another part of the controlling device 601/701 may be integrated with the display device 620/720 to control the display device 620/720. In this case, the two parts of the controlling device 601/701 may operate synchronously via, for example a communication unit (e.g. communication interfaces configured in the two parts).

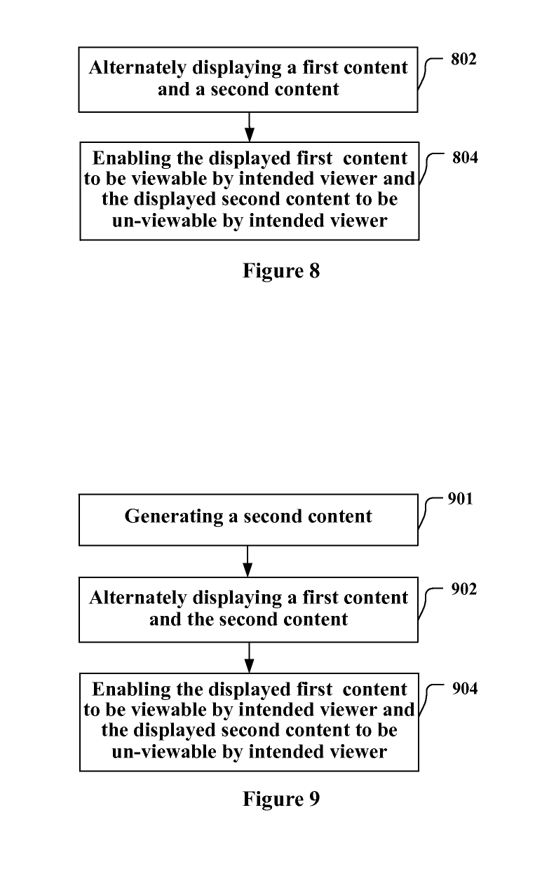

FIG. 8 is a schematic flow chart illustrating a method for securing displayed contents according to an embodiment of the disclosure. As shown in FIG. 8, the method may include the following steps 802 and 804.

In step 802, a display device is controlled to alternately display a first content and a second content. As in the above embodiments and examples, the first content refers to the content containing information intended to be viewed by an intended viewer and the second content refers to the content containing interferential information and is also called the interferential content.

In step 804, the displayed first content is made viewable by the intended viewer and the displayed second content is made un-viewable by the intended viewer.

With the method, what a non-intended viewer sees from the displayed contents is a visually unrecognizable vision of a combination of alternately displayed first and second contents, while what an intended viewer sees is the displayed first content since the second content is made un-viewable to him/her. In this way, the displayed contents can be kept confidential to the non-intended viewer.

FIG. 9 is a schematic flow chart illustrating a method for securing displayed contents according to another embodiment of the disclosure.

As shown in FIG. 9, the method may include the steps 902 and 904 which are similar to the steps 802 and 804 as shown in FIG. 8. In addition, the method may further include a step 901 of generating the interferential content to be displayed by the display device as interference to the first content. As described in the above embodiments and examples, the interferential content may be generated in many ways, the description of which is not repeated herein. Of course, the above examples for generating the interferential content are only illustrative, and should not be regarded as limiting the disclosure thereto.

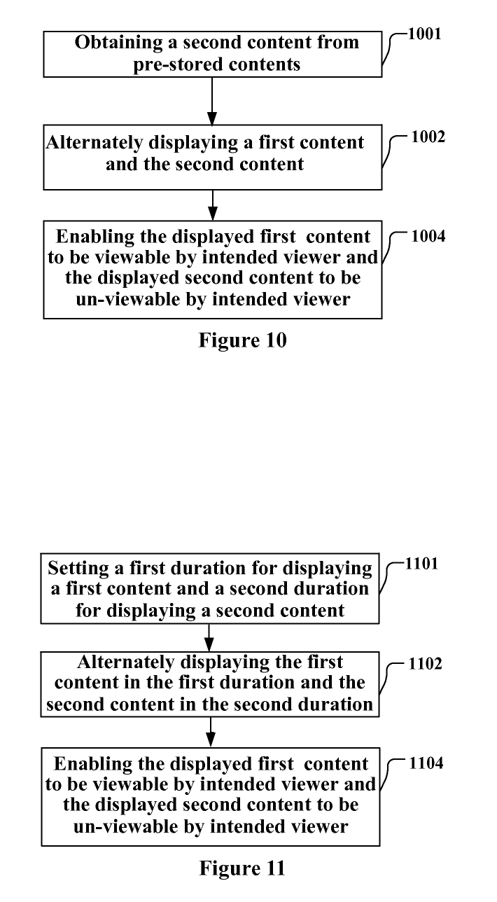

FIG. 10 is a schematic flow chart illustrating a method for securing displayed contents according to another embodiment of the disclosure.

In the embodiment as shown in FIG. 10, the method may include the steps 1002 and 1004 which are similar to the steps 802 and 804 as shown in FIG. 8. In addition, the method may further include a step 1001 of obtaining the interferential content from pre-stored contents. The obtained interferential content is then used by the display device as interference to the first content. As described above, the pre-stored interferential content may be, for example, an image with text displayed thereon (e.g. Content B as shown in FIG. 2), a graphical image (e.g. a photo of car, or an image, such as Content D, obtained by shifting the position of content in a captured image), a blank image with certain color (e.g. black), video images, or other appropriate visual contents.

FIG. 11 is a schematic flow chart illustrating a method for securing displayed contents according to another embodiment of the disclosure.

As shown in FIG. 11 the method may include the steps 1102 and 1104 which are similar to the steps 802 and 804 as shown in FIG. 8. In addition, the method may further include a step 1101 of setting a first duration for displaying the first content and a second duration for displaying the second content. In the embodiment, the durations of displaying the first and second contents can be set and adjusted so as to achieve an advantageous screen securing effect. As described above, the first and second durations may be set and adjusted automatically or may be set and adjusted manually by a viewer/user.

It shall be appreciated that, though in FIG. 11 the step 1101 is shown to be before the steps 1102 and 1104, the disclosure should not be regarded as limited to this. In other examples, the first and second durations can be adjusted at any time during the process of displaying the first and two contents.

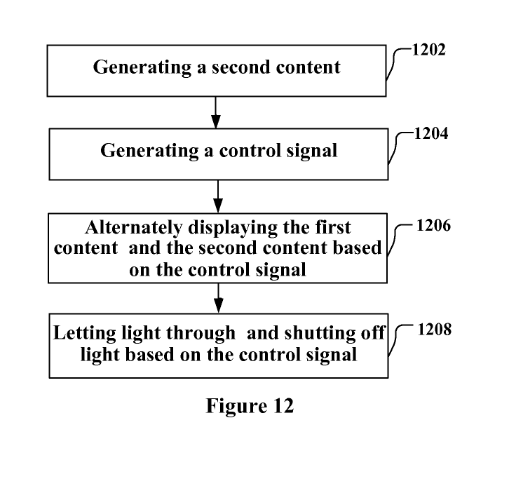

FIG. 12 is a schematic flow chart illustrating a method for securing displayed contents according to another embodiment of the disclosure.

As shown in FIG. 12, the method may include steps 1202, 1204, 1206 and 1208. In the method, to enable the displayed first content to be viewable by an intended viewer and the displayed second content to be un-viewable by the intended viewer, a viewing device may be disposed between the display device and the eyes of the intended viewer.

In step 1202, the second content to be displayed by the display device may be generated. The second content may be displayed as interference to the content (i.e. the first content) containing information to be viewed by an intended viewer. As stated above, the second content may be generated in many ways. As an example, the image of the first content (e.g. the Content A as shown in FIG. 3) displayed on the display device can be captured, then the image of the second content (e.g. the Content D as shown in FIG. 3) can be generated by shifting the position of the content in the captured image in any arbitrary direction. As another example, the second content may be generated using a text that contains arbitrary symbols, letters or words (e.g. Content B as shown in FIG. 2), or using any graphical image or video or other appropriate visual contents. The described examples for generating the interferential content are only illustrative, and should not be regarded as limiting the disclosure thereto.

In step 1204, a control signal may be generated. The control signal may have at least two signal states (referred to as a first state and a second state). For example, the control signal may be a sequence of alternate 1s and 0s over time, and the 1s and 0s can have different durations, respectively. As described above, the durations can be set to any appropriate values according to the practical requirements, and may be set and adjusted automatically, or may be set and adjusted by a user.

The control signal may be sent to both of the display device and the viewing device so that the two devices may operate synchronously based on the control signal.

In step 1206, the first content and the second content are alternately displayed on the display device based on the control signal. As an example, the first content is displayed during the durations of the first state of the control signal and the second content is displayed during the durations of the second state of the control signal.

In step 1208, the viewing device may be turned on/off alternately according to the control signal so that light is let through or shut off alternatively. As an example, when the control signal is in the first state and the first content is displayed, the viewing device may be turned on to allow light to go through, such that the content displayed on the display screen can be seen by the intended viewer/user, and when the control signal is in the second state and the second content is displayed, the viewing device may be turned off to block light such that the second content displayed on the screen can not seen by the intended viewer/user. Some particular examples of the viewing device have been described above, and are not repeated herein.

In the above embodiments/examples, the display screen of the display device may be a Liquid Crystal Display (LCD), an Organic Light Emitting Display (OLED), a Plasma Display Panel (PDP), a Cathode-ray Tube (CRT), or the like.

In addition, the method, for securing displayed contents according to the embodiments of the disclosure may be implemented by a program product or a set of program instructions that can be operated on any information processing device. The information processing device may be any appropriate processing device, such as a computer, a hand-held device, or an embedded device or the like. Therefore, such program product or program instructions, as well as machine-readable medium storing the program product or program instructions thereon, also constitute part of the disclosure. The machine-readable medium may include any existing and future storage medium.

Furthermore, some components in the above described systems 100/400/500/600/700, including the controlling device 101/401/501/601/701, the storage module 504, and the interference generating module 403, etc, may be realized as software components that can be operated on a chip, or may be realized by a specialized circuit, e.g. a single chip or the like. Therefore, such software components and/or circuits (e.g. chips) also constitute part of the disclosure.

It can be understood by a person of ordinary skill in the art that there is little distinction left between hardware and software implementations of the aspects of the apparatus described above; the use of hardware or software is generally (but not always, in that in certain contexts the choice between hardware and software can become significant) a design choice representing cost vs. efficiency tradeoffs. There are various vehicles by which processes and/or apparatuses and/or other technologies described herein can be effected (e.g., hardware, software, and/or firmware), and that the preferred vehicle will vary with the context in which the processes and/or apparatuses and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” or “comprising” should be interpreted as “including but not limited to,” the term “having” should be interpreted as “having at least,” the term “includes” or “comprises” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for securing contents displayed on a display device, comprising:
a communication module, adapted to communicatively connect the display device to a first device; and
the first device, adapted to control, via the communication module, the display device to alternately display a first content and a second content, the second content containing interference information.

2. The system according to claim 1, further comprising an interference generating module adapted to generate the second content.

3. The system according to claim 2, wherein:
the interference generating module is adapted to generate the second content by capturing an image of the first content and shifting a position of the image of the first content.

4. The system according to claim 1, further comprising a storage module adapted to store the second content, wherein the second content displayed on the display device is obtained from the storage module.

5. The system according to claim 1, wherein:
the first device is further adapted to set and adjust a first duration for displaying the first content and a second duration for displaying the second content.

6. The system according to claim 1, further comprising:
a second device, adapted to let light through when the first content is displayed and shut off light when the second content is displayed.

7. The system according to claim 6, wherein:
the second device is further adapted to be controlled by the first device to let light through when the first content is displayed and shut off light when the second content is displayed.

8. The system according to claim 7, wherein:
the first device is further adapted to generate a control signal and send the control signal to both the display device and the second device, so that the display device alternately displays the first content and the second content based on the control signal, and the second device alternately lets light through and shuts off light based on the control signal.

9. A device for permitting displayed content to be viewed while securing the displayed content, comprising:
a light blocking device adapted to be alternately:
turned on to let light through when first content is displayed on a display device; and
turned off to shut off light when second content is displayed on the display device.

10. The device according to claim 9, wherein:
the light blocking device comprises a pair of polarizing sheets disposed in parallel, polarizing directions of the two polarizing sheets are parallel with each other and perpendicular to each other alternately.

11. The device according to claim 9, wherein:
the light blocking device comprises a pair of spectacles which are adapted to simultaneously let light through and simultaneously shut off light.

12. The device according to claim 9, wherein:
the light blocking device comprises:
a first polarizing sheet; and
a pair of spectacles, each of the spectacles having a polarizer, wherein a polarizing direction of the first polarizing sheet is alternately parallel with those of the spectacles and perpendicular to those of the spectacles.

13. The device according to claim 9, wherein:
the light blocking device is adapted to receive a control signal and alternately let light through and shut off light based on the control signal.

14. A method for securing displayed contents, comprising:
alternately displaying a first content and a second content, the second content containing interference information; and
enabling the displayed second content to be un-viewable by an intended viewer.

15. The method according to claim 14, further comprising:
generating the second content.

16. The method according to claim 14, further comprising:
obtaining the second content from pre-stored contents.

17. The method according to claim 14, further comprising:
setting a first duration for displaying the first content and a second duration for displaying the second content.

18. The method according to claim 14, further comprising:
generating a control signal so that the first and second contents are displayed alternately based on the control signal and the displayed second content is enabled to be un-viewable based on the control signal.

19. The method according to claim 15, wherein generating the second content comprises:
generating the second content by capturing an image of the first content and shifting position of the image of the first content.

20. The method according to claim 14, wherein enabling the displayed second content to be un-viewable by the intended viewer comprises:
letting light through by a viewing device disposed between the intended viewer and the displayed contents when the first content is displayed and shutting off light by the viewing device when the second content is displayed.
